(19) United States
(12) Patent Application Publication
(10) Pub. No.: US 2022/0299224 A1
(43) Pub. Date: Sep. 22, 2022

(54) PROACTIVE ADJUSTMENT OF CLIMATE CONTROL SYSTEM

(71) Applicant: Lenovo (Singapore) Pte. Ltd., Singapore (SG)

(72) Inventors: Russell Speight VanBlon, Raleigh, NC (US); John Carl Mese, Cary, NC (US); Mark Patrick Delaney, Raleigh, NC (US); Arnold S. Weksler, Raleigh, NC (US); Nathan J. Peterson, Oxford, NC (US)

(21) Appl. No.: 17/205,608

(22) Filed: Mar. 18, 2021

(51) Int. Cl. F24F 11/30; F24F 11/56; F24F 11/62; F24F 11/64; F24F 11/65; F24F 11/80; G05B 13/02

(52) U.S. Cl. CPC F24F 11/30; F24F 11/56; F24F 11/62; F24F 11/64; F24F 11/65; F24F 11/80; G05B 13/026; G05B 13/027; F24F 2110/10

(57) ABSTRACT

In one aspect, a device may include at least one processor and storage accessible to the at least one processor. The storage may include instructions executable by the at least one processor to predict, at a first time and using a first device, that one or more settings of a climate control system should be changed in advance of a second time that transpires after the first time. The instructions may then be executable to, based on the prediction, proactively change one or more settings of the climate control system in advance of the second time. For example, the temperature of a thermostat may be proactively changed based on the prediction.

### FIELD

The disclosure below relates to technically inventive, non-routine solutions that are necessarily rooted in computer technology and that produce concrete technical improvements. In particular, the disclosure below relates to techniques for proactive adjustment of a climate control system.

### BACKGROUND

As recognized herein, Internet of things (IoT) devices are becoming more and more ubiquitous in modern society. However, as also recognized herein, these IoT devices are not networked to interact with each other as best they could and do not execute various functions as effectively and fast as they could. There are currently no adequate solutions to the foregoing computer-related, technological problem.

### SUMMARY

Accordingly, in one aspect a first device includes at least one processor and storage accessible to the at least one processor. The storage includes instructions executable by the at least one processor to determine a biometric of a user that exists at a first time and to predict that, at a second time after the first time, a temperature of a thermostat should be changed based on the biometric. The instructions are then executable to change the temperature of the thermostat in advance of the second time. For example, the temperature of the thermostat may be changed at a threshold time prior to the second time.

In various example implementations, the biometric may be a body temperature of the user and/or a heart rate of the user.

Also in various example implementations, the biometric may be determined based on data received from a second device different from the first device. The second device may include a wearable device coupled to the user during the first time.

Still further, if desired the prediction may be based at least in part on a history of past biometrics of the user and associated past times at which the temperature of the thermostat was changed by the user. Additionally or alternatively, the prediction may be made using an artificial neural network tailored through machine learning of past biometrics of the user and associated past times at which the temperature of the thermostat was changed by the user.

Additionally, note that in some examples the thermostat may be an Internet-connected device different from the first device. Also in some examples, the first device may be embodied in a server that communicates with the thermostat.

Moreover, if desired the instructions may be executable to correlate the biometric to physical activity and to make the prediction based on the biometric being correlated to physical activity. The physical activity may include cleaning, playing a sport, bathing, and/or showering. The physical activity may even be identified from electronic calendar data in certain examples.

Also in some example embodiments, changing the temperature of the thermostat may command the thermostat to decrease operation of a heater and/or increase operation of an air conditioning unit.

In another aspect, a method includes predicting, at a first time and using a first device, that a temperature of a network-connected thermostat should be changed in advance of a second time after the first time. The method then includes, based on the predicting, proactively changing the temperature of the thermostat in advance of the second time.

In some example implementations, the method may include predicting, at the first time, that a user will be cooking during the second time and then predicting that the temperature of the thermostat should be changed in advance of the second time based on the predicting that the user will be cooking during the second time. The predicting that the user will be cooking during the second time may be based on a history of past user activity, identification that a cooking appliance has been turned on, and/or identification that the user has begun food preparation.

Also in some example implementations, the method may include predicting that the temperature of the thermostat should be changed in advance of the second time based on identification of a lack of physical activity by a user for at least a threshold time. Additionally or alternatively, the method may include predicting that the temperature of the thermostat should be changed in advance of the second time based on identification of the user as sitting down and/or using an electronic device.

In various examples, the predicting may be performed based on a history of past user activity and/or using a trained artificial neural network.

In still another aspect, at least one computer readable storage medium (CRSM) that is not a transitory signal includes instructions executable by at least one processor to predict, at a first time and using a first device, that one or more settings of a climate control system should be changed in advance of a second time that transpires after the first time. The instructions are then executable to, based on the prediction, proactively change one or more settings of the climate control system in advance of the second time.

In some examples, the instructions may be executable to change one or more settings of the climate control system by turning on or off at least one overhead fan controlled by the climate control system.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a block diagram of another example network of devices consistent with present principles, with the devices of FIG. 3 including various components of a climate control system;

FIG. 4 is an example illustration of how a climate control system can be proactively controlled while a user engages in physical activity consistent with present principles;

FIG. 5 shows example logic in example flow chart format that may be executed by a device to adjust settings of a climate control system consistent with present principles;

FIG. 6 shows an example graphical user interface (GUI) that may be presented on a display to adjust one or more settings of a climate control system consistent with present principles; and

FIG. 7 shows an example GUI that may be presented on a display to establish various rankings or priority levels for various users of a climate control system consistent with present principles.

### DETAILED DESCRIPTION

Among other things, the detailed description below discusses electronic devices that may learn user preferences for various temperatures of the user's heating, ventilation, and air conditioning (HVAC) system depending on what activity the user has just finished or is still engaging in and correlates those preferences to future activities to proactively adjust the temperature in the future. If a user typically turns on an overhead fan during or after an activity, that may be learned as well.

For example, a user may be determined to be playing tennis as detected via a calendar entry, wearable device, associated smartphone location, etc. The system may monitor that the user typically goes directly home after the activity is done and adjusts down the target temperature for the thermostat since the user is too hot from playing tennis. The system may correlate the temperature adjustment to the preceding activity (playing tennis) so that next time the user plays tennis, similar adjustments to the target temperature and hence home air temperature itself may be made in advance so the home is already set to the learned temperature when the user gets home.

Thus, in some examples in the winter, the home may be heated more depending on the activity. In other examples in the summer, the home may be cooled more depending on the activity.

Also note that activities that can be accounted for are not limited to playing sports and may also include cleaning the house itself or another activity inside or outside of the house since users might often be too hot when active based on the default room temperature and may wish that the heat be turned down or air conditioning turned up.

As another example, the system may also proactively detect when the user(s) shower based on past usage patterns and adjust the target temperature for the associated bathroom and connected bedroom to avoid those rooms being too hot or cold before and/or after the shower. But the comfort of the temperature of other rooms in the house may still be balanced by the system by not adjusting their own respective target temperatures or otherwise leaving their current temperatures the same.

A wearable device like a smartwatch or health monitor may even detect body temperature and proactively adjust HVAC settings, even if user is away from the home, so the home's air temperature is comfortable when the user gets home.

Additionally, the system may track the user around their house using GPS data or even ultra-wideband (UWB) location tracking to turn on overheard fans in whatever room the user is currently in when the temperature in that room gets too hot for the user's preconfigured temperature preference(s). The system might also aggregate multiple users at the home and assign them different levels of priority for which of their personal target temperatures to apply when two or more of them are present. For example, elderly people may be prioritized first, then guests, then the matriarch of the household, then the patriarch of the household, and then children of the household.

As another example that incorporates present principles, suppose an end user is standing over a stove, moving around doing cooking. The user could get very hot and adjust the temperature for that room down at the thermostat, which could be learned by the system/thermostat itself. The next time the user cooks, the system could then proactively lower the temperature to the same temperature the user lowered it to before, in advance of when cooking is expected based on past history. The temperature might also be proactively lowered as soon as the smart stove/oven is turned on, and/or as soon as cooking activities begin (such as the user beginning food preparation by mixing things in a bowl, taking things out of the fridge, etc.). Thus, cooking activities beginning and/or the stove/oven being turned on may be reported by the stove/oven or other smart appliance itself, and/or may be determined based on input from a camera in the environment and execution of object and activity recognition software to identify the activity (e.g., food preparation).

As another example, when the user is working at their desk in their home office for long periods of time, the user might get cold due to a lack of physical activity and adjust the target temperature for the home office room accordingly. When the system determines the same condition exists in the future for at least a threshold amount of time (e.g., thirty minutes), it may proactively adjust the target temperature up to warm the user.

As but one more example, suppose the user's elderly parent comes over to the user's house. Based on the elderly person having a higher ranking than the user himself or herself, the system may proactively raise the target temperature for the entire home so that the elderly person is comfortable no matter which room he/she goes into. Thus, temperature adjustments may not necessarily always be activity-based and may also be based on profile data and assigned priority levels for various people.

More generally, it is to further be understood that user preference for temperature adjustments may be correlated for each person in the home that makes adjustments. Different temperatures may then be set for each user upon detecting an activity associated with that user if, for example, one user reduces the thermostat temperature more than another user after performing the same activity (e.g., exercising). Moreover, multiple users can be prioritized as configured by the device/system owner so that, for example, specific user/event combinations could be prioritized over other combinations or other users more generally. E.g., a child may be prioritized when taking a bath, but otherwise the learned thermostat temperature for the parents of the child may take priority.

Thus, proactive adjustment of temperatures may be executed before the relevant user has already gotten uncomfortable with the current temperature.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

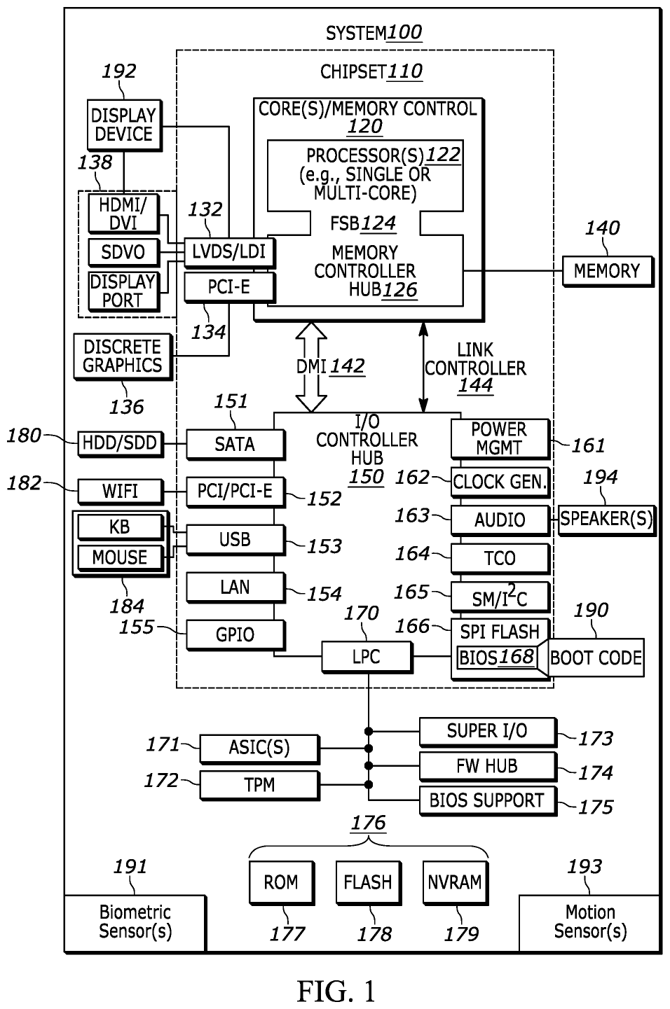

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include one or more biometric sensors 191 for sensing biometrics of a user consistent with present principles. Thus, the sensors 191 may include, for example, an electromyograph, a pulse/heart rate sensor, a retina and/or iris sensor, a blood pressure sensor, a perspiration sensor, an odor and/or scent sensor, a body or skin temperature sensor, a lung input/output sensor, a blood oxygen sensor, a glucose and/or blood sugar sensor, a brain activity sensor, etc.

Additionally, in some embodiments the system 100 may include one or more motion sensors 193 such as a gyroscope that senses and/or measures the orientation of the system 100 and provides related input to the processor 122. The sensor(s) 193 may also include an accelerometer that senses acceleration and/or movement of the system 100 and provides related input to the processor 122. Additionally, the sensor(s) 193 may include a magnetometer/compass that senses the strength of a magnetic field and/or dipole moment to then provide related input to the processor 122 to determine the system 100's heading and/or direction relative to the Earth's magnetic field.

Still further, though not shown for simplicity, the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video. Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

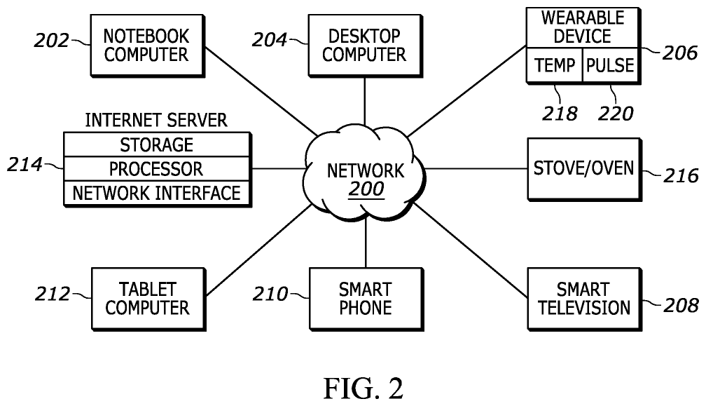

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a smart Internet of things (IoT) cooking appliance 216, and a server 214 such as an Internet server that may provide cloud storage accessible to the devices 202-212, 216. It is to be understood that the devices 202-216 may be configured to communicate with each other over the network 200 to undertake present principles, such as communicating biometric information and device status information between various devices.

Still in reference to FIG. 2, note that the appliance 216 may be a smart oven and/or stove, a smart toaster, a smart crockpot, or any other cooking appliance that might be used for cooking food for consumption. Also note that the wearable device 206 may include one or more biometric sensors such as a temperature sensor 218 and pulse sensor 220 (and/or another one of the sensors 191 described above) to sense respective temperature and pulse/beats per minute of a user when the wearable device 206 is coupled to the user around his/her wrist or elsewhere. The wearable device 206 might also include one or more of the motion sensors 193.

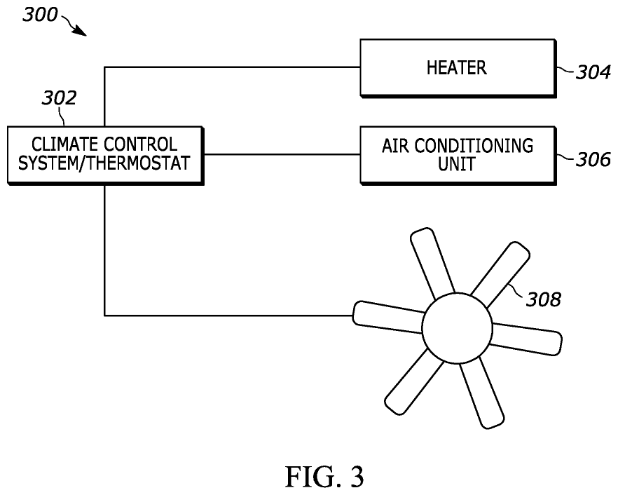

FIG. 3 shows additional devices that may be networked with the system 100 and/or devices of FIG. 2 to undertake present principles. As shown, a smart climate control system 300 such as a heating, ventilation, and air conditioning (HVAC) system may include a climate control system computer and/or thermostat 302, though a central IoT hub or other home networking device such as a laptop computer may also be used. The computer/thermostat 302 may control various aspects of the climate control system 300, including a heater 304, air conditioning unit 306, and/or one or more overhead fans 308 mounted to the ceiling(s) of a building in which the system 300 and components 304-308 are disposed.

The heater 304 may emit heated air that may be carried through various ducts of the system 300 to various vents in various rooms of the building to output the heated air into the various rooms. The air conditioning unit 306 may emit cooled air that may also be carried through the various ducts to the various vents to output the cooled air into the various rooms. The overhead fans 308 may have respective motors electronically controlled to spin the blades of the respective fan 308 clockwise or counter-clockwise to blow air downwards from the ceiling into other portions of the respective room in which the respective fan 308 is disposed.

Additionally, if desired, climate control of the various rooms in the building in which the system 300 is disposed may be localized so that various rooms may be maintained at different temperatures using the components 304-308, independent of the temperature of other rooms. The computer 302 may therefore control the opening and closing of various ducts and/or vents of the system 300 via respective motors, as well as the selective operation of the components 304-308, to achieve independent climate control of the various rooms. Additionally, note that communication between the various components 302-308 may be performed using Wi-Fi communication, Bluetooth communication, ultra-wideband (UWB) communication, etc.

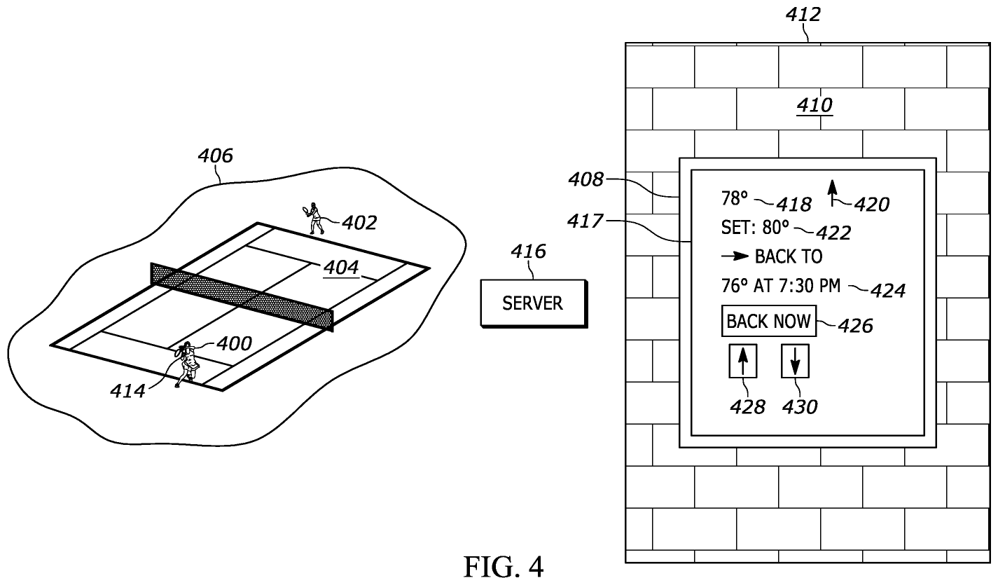

Continuing the detailed description in reference to FIG. 4, suppose an end-user 400 is playing tennis with another person 402 on a tennis court 404 at a first location 406. Also suppose that a smart thermostat 408 similar to the computer 302 is mounted on a wall 410 of a personal residence that is at a second location 412 that is remotely-located from the location 406, such as being twenty miles or so away.

While the user 400 plays tennis, the user's wearable smartwatch 414 as coupled to the user's left wrist may report one or more biometric readings from the user 400 (as sensed by one or more of its biometric sensors) to a cloud server 416, which may then analyze the readings and control the thermostat 408 as set forth further below. Additionally, or alternatively, the server 416 may relay the readings to the thermostat 408 at the second location 412 for analysis by the thermostat 408 itself. The readings themselves may include, for example, a body temperature of the user 400 and/or a heart rate of the user 400.

The analysis above may be conducted on the user's biometrics to correlate certain biometric levels such as body/skin temperature and heart rate to physical activity generally or to certain specific types of physical activity. A relational database may therefore be used for the correlation, where the database correlates various biometric levels to physical activity generally or to specific types of physical activity (or additionally or alternatively, correlates various biometrics directly to target air temperatures themselves). The same relational database might also correlate various biometric levels to a lack of physical activity. But regardless, for physical activity generally, for different types of physical activity, and/or for lack of physical activity, the relational database may correlate those various entries to various target air temperatures at which the thermostat 408 should be set so that the indoor climate controlled by the thermostat 408 may reach the target temperature by the time the user 400 arrives at the location 412 after playing tennis.

The respective target temperatures may be learned and populated into the relational database over time based on past identified instances of physical activity or the lack thereof, and/or past identified biometrics themselves, and corresponding temperatures to which the target temperature of the thermostat 408 was changed after the identified activity transpired or biometric was identified. For example, to qualify for correlation, the target temperature may have to be set by the user 400 within a threshold time after the activity ends (or lack of activity ends) or within a threshold time after the biometric is identified (or exceeds a specific threshold such as a temperature threshold). Thus, in this example the relational database may establish a history of past biometrics and/or activity of the user 400 and associated past times at which the temperature of the thermostat was changed by the user 400. However, further note that until user-specific target temperatures are populated into the relational database, default target temperatures for the various activities may be used as populated by the creator of the database.

Additionally, in some examples the smartwatch 414 of FIG. 4 may also report motion sensor readings to the server 416, such as gyroscope and/or accelerometer data indicating motion of the watch 414 while the user 400 plays tennis. The server 416 may then analyze the readings themselves or send them to the thermostat 408 for analysis, but in either case the analysis may correlate certain predefined movement or movement sequences with physical activities of various types using a relational database indicating the respective correlations and respective target temperatures themselves for each correlation. Again note that the target temperatures may be populated into the database based on past instances of the user 400 changing the target temperature within a predetermined amount of time of identification of the physical activity (or lack thereof) ending.

Still further, note that physical activity (or the lack thereof) may also be determined still other ways. For example, physical activity may be identified based on input from one or more cameras imaging the user to determine, using object and/or activity recognition, the activity being engaged in to then determine a target temperature from a relational database as described above once the activity has been identified through camera input. Data from a microphone may be similarly used once voice recognition has been executed to identify words spoken by the user that indicates an activity.

As yet another example, an electronic calendar of the user 400 may be accessed to correlate keywords from a certain calendar entry corresponding to a current time of day to physical activity (e.g., “tennis”, “workout”). A location of the activity as indicated in the calendar entry may also be correlated to physical activity based on known locations of physical activity. Thus, here too a relational database may be used that correlates various keywords/locations to various physical activities along with respective target temperatures for those physical activities as determined from past user target temperature adjustments.

Map data may also be used, such as data from Google Maps, to correlate a particular known location at which the user 400 is currently disposed to a particular physical activity to thus identify a corresponding target temperature from a database as described above. The particular location may be reported via GPS coordinates from the watch 414, for example, though the location may also be determined via UWB or other location tracking technologies.

Additionally, note further that predicting that the target temperature of the thermostat 408 should be changed may be based on inferences from an artificial intelligence (AI) model in addition to or in lieu of using the database(s) described above. The AI model may include one or more deep artificial neural networks (ANNs) tailored through machine learning of past biometrics of the user 400 and associated past times at which the target temperature of the thermostat 408 was changed by the user 400. The deep ANNs may include, for example, one or more recurrent neural networks (RNNs). And being deep neural networks, each ANN may include an input layer, output layer, and multiple hidden layers in between that are configured and weighted to make inferences about an appropriate target temperature given a set of inputs such as user biometrics and/or physical activities that have been identified as being performed by the user 400. Each ANN may be trained in supervised fashion and/or may be trained unsupervised through machine learning to tailor the neural network to make the inferences from the various inputs. In some examples, each user adjustment of the target temperature after a given biometric reading has been reported or physical activity identified may be used to trigger additional training of the ANN to further tailor it to the specific user 400.

Then, once a respective target temperature has been identified through a relational database or ANN(s) according to the description above, the server 416 and/or thermostat 408 may control the temperature setting for the thermostat 408 to increase or decrease the thermostat's target temperature to match the identified target temperature determined from biometrics and/or an activity. Again note that the thermostat's target temperature may be localized to the current location of the user in a certain room but possibly not all rooms for a given building. Further note that the room(s) in which the user 400 might go after arriving home from a physical activity elsewhere may also be tracked and saved for the thermostat 408 to infer that changes to the target temperatures of those particular rooms should be made in the future when the same activity is performed again to thus proactively change the temperature to the target before the user 400 arrives home again.

Still in reference to FIG. 4, note that changing the target temperature at the thermostat 408 may in turn command or otherwise instigate the thermostat 408 to decrease operation of a heater (e.g., power off or reduce its heat output) and/or increase operation of an air conditioning unit (e.g., power on or increase its cooled air output). Changing the target temperature may also command the thermostat 408 to increase or slow down the rotation speed of an overhead fan such as the fan 308 if located in a target area/room of the location 412 at which the user is predicted to be in the future after arriving from the location 406.

As also shown in FIG. 4, the display of the thermostat 408 may include a graphical user interface (GUI) 417 indicating a current room/location temperature 418 as well as an up-arrow indication 420 that the current room temperature 418 is in the process of being raised to a target temperature 422 also indicated on the display. Note further that an indication 424 may be presented indicating a default target temperature to which the current target temperature will go back to at a certain later time of day, such as a threshold time after the user 400 arrives at the location 412 or a threshold time after an identified activity ends, such as two hours later to give the user's body temperature or other biometrics time to come back down to a non-active level after engaging in the physical activity.

However, if desired the GUI 417 may also include a selector 426 that may be selectable to command the thermostat 408 to re-adjust the current target temperature immediately back to the default target temperature rather than the dynamic temperature that was determined based on the user's biometrics and/or activity. Note further that an up selector 428 and down selector 430 may also be presented for the user to provide additional input to adjust the current target temperature up or down respectively.

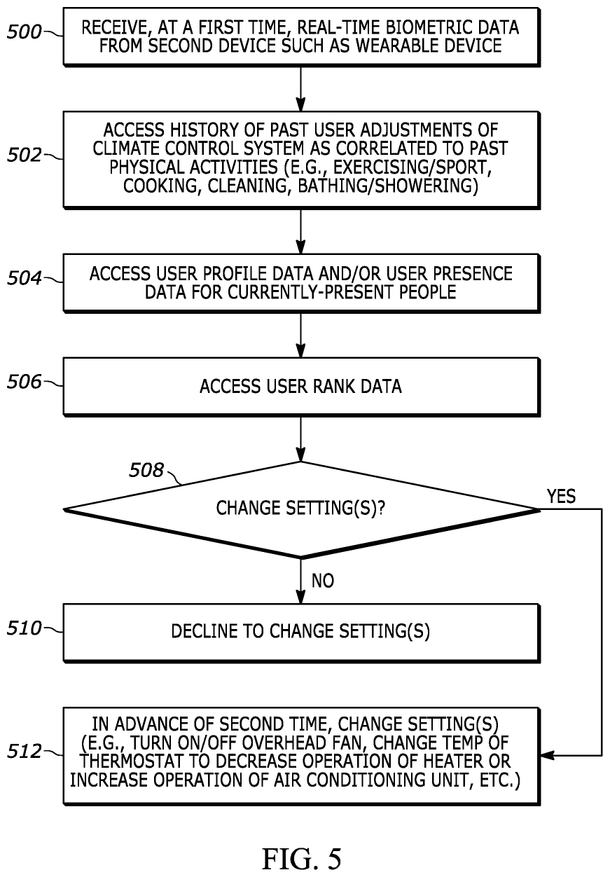

Now in reference to FIG. 5, it shows example logic that may be executed by one or more first devices in any appropriate combination consistent with present principles. For example, the logic of FIG. 5 may be executed by a local climate control system computer and/or remotely-located server. Note that while the logic of FIG. 5 is shown in flow chart format, state logic or other suitable logic may also be used.

Beginning at block 500, the first device may receive, at a first time, real-time biometric data from a second device, such as the wearable smartwatch 414 described above. From block 500 the logic may then proceed to block 502.

At block 502 the first device may access a history of past user adjustments of the climate control system as correlated to past physical activities, such as but not limited to exercising/sport, cooking, cleaning, walking around the house, bathing/showering, etc. Again note that the history may take the form of a relational database as described above or may take other form.

From block 502 the logic may then proceed to block 504 where the first device may access user profile data and/or user presence data for currently-present people already at the location controlled by the climate control system. For example, cameras and/or microphones at the location may be used to identify, via facial or voice recognition respectively, particular people that are already present at the location. A respective personal device of each person may also be identified based on wireless ID signals from each device. The first device may then access stored profile data for the identified person to determine a respective ranking for that person from the profile and a respective target temperature that the person prefers. This may then be used at block 506 to access a ranking list or other user ranking data for ultimately giving target temperature priority to one person or another based on the rankings.

Thus, after block 506 the logic may proceed to decision diamond 508 where the first device may determine whether to change one or more settings of the climate control system/thermostat, such as its target temperature. The determination at diamond 508 may be performed by comparing a desired target temperature identified as described above per a database or ANN to a currently-set target temperature to determine whether an adjustment should be made to set the climate control system to the identified target temperature.

Responsive to a negative determination at diamond 508, the logic may proceed to block 510 where the first device may decline to change the target temperature setting or other settings. However, responsive to an affirmative determination at diamond 508, the logic may instead proceed to block 512.

At block 512 the first device may, in advance of a second time that transpires after the first time, change the setting(s). For example, an overhead fan that was off may be placed in the on configuration to begin spinning. As another example, the current target temperature may be changed to the identified target temperature for the user's activity to thus decrease operation of the system's heater and/or increase operation of system's air conditioning unit, or vice versa. For example, room temperature may be decreased responsive to an increased user temperature or heart rate (or identification of associated physical activity), whereas room temperature may be increased responsive to decreased user temperature or heart rate (or identification of a lack of physical activity).

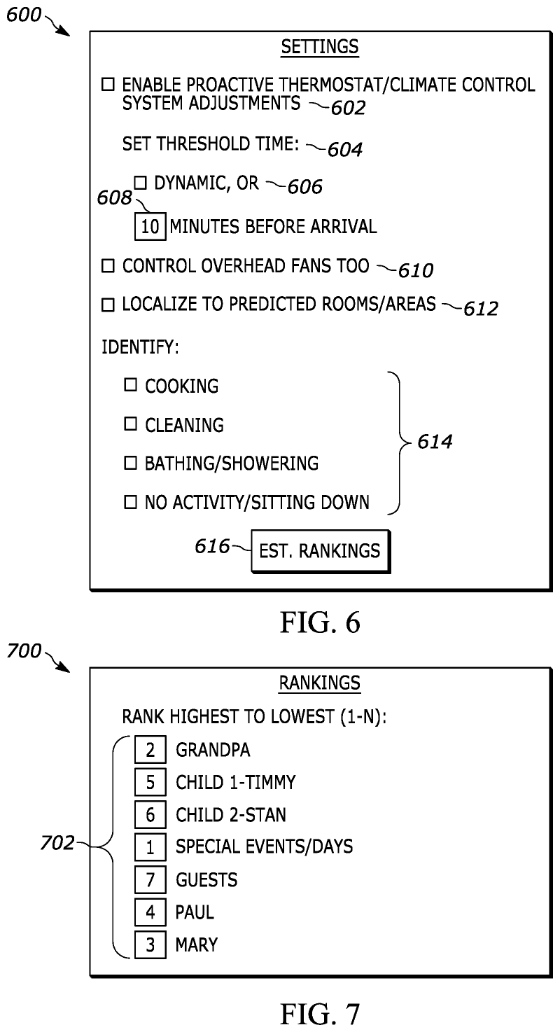

Now in reference to FIG. 6, it shows an example GUI 600 that may be presented on the display of a device that is configured to undertake present principles, such as the display of the first device of FIG. 5 and/or the display of a smart thermostat or climate control system computer. The GUI 600 may be presented based on navigation of a settings menu and may be used for configuring one or more settings of the relevant climate control system to operate consistent with present principles. It is to be understood that each option to be discussed below may be selected by directing touch or cursor input to the respectively adjacent check box.

As shown in FIG. 6, the GUI 600 may include a first option 602 that may be selectable to set or configure the first device to, in the future, proactively change one or more settings of the climate control system in advance, such as changing the target temperature of the system's thermostat. For example, selection of the option 602 may set or enable the system to undertake the logic of FIG. 5 as well as to execute the various functions described above in relation to the server 416 and/or thermostat 408.

Additionally, the GUI 600 may include a setting 604 at which a threshold time prior to arrival of a user at a location may be set. At the threshold time, the system may begin trying to reach a certain target temperature determined based on the user engaging in physical activity or exhibiting a certain biometric level. Thus, option 606 may be selected for the system to dynamically determine the threshold time based on target temperature, current air temperature, and a known rate of heating or cooling, for example, so that the target temperature is reached prior to the user's predicted arrival time. However, if desired, the user may enter numerical input to input box 608 to set a particular threshold time to use as the time prior to predicted arrival at which the system should begin attempting to reach the target temperature.

As for the user's predicted time of arrival itself, it may be determined based on a history of past arrival times under similar circumstances, real-time GPS location tracking of another device associated with the user as the user travels toward the destination (e.g., tracking the smartwatch 414), and/or a calculated time of arrival based on one or more rates of driving and a distance from the user's known current location to the destination.

Additionally, in some examples the GUI 600 may include an option 610 that may be selectable to specifically set or enable the system to not just use the system's heater and air conditioning unit to proactively change a room temperature for a user, but to also use overhead fans as described herein. The GUI 600 may further include an option 612 that may be selectable to set or enable the system to use localized climate control to independently vary the temperature of various rooms of the building according to different users' rankings and identified activities in those respective rooms.

Still further, if desired the GUI 600 may include a list of one or more options 614 that may be respectively selectable to select various different types of activities for which proactive temperature control should be performed. As shown, the options 614 may include an option to select cooking as one of the activities, an option to select cleaning (e.g., cleaning the house) as one of the activities, an option to select bathing and/or showing in the building as one of the activities, and an option to select a lack of physical activity, the user sitting down, and/or the user using a personal device while inactive for at least a threshold amount of time as one of the activities.

The GUI 600 may also include a selector 616 that may be selected to initiate a process for a user or administrator to establish rankings for various people for applying their respective target temperature consistent with present principles. For example, the selector 616 may be selected to present the GUI 700 of FIG. 7.

As shown in FIG. 7, the GUI 700 may include a respective input box 702 next to each registered user. A person may enter a different number into each box to establish the respective registered user's ranking. Users may be ranked from highest to lowest, one to “N”, or using another ranking system.

As also shown on the GUI 700, not every one of the boxes might correspond to a person per se but may also correspond to another factor that should be accounted for by the system. For example, holidays and special events may be ranked higher than other items if, for example, a certain special event, holiday, and/or date is correlated to cooking occurring within the building and therefore a potential need to proactively adjust the thermostat temperature to cool the building more as kitchen appliances create heat. As another example, though not shown for simplicity, there may be an option that a child have a lower ranking than an adult except when the child is identified as about to bathe/shower or actually bathing/showering.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A first device, comprising:
at least one processor; and
storage accessible to the at least one processor and comprising instructions executable by the at least one processor to:
present a settings graphical user interface (GUI) on a display, the settings GUI comprising an option that is selectable to set the first device, for multiple future instances, to:
determine a biometric of a user that exists at a first time;
predict that, at a second time after the first time, a temperature of a thermostat should be changed based on the biometric; and
in advance of the second time, change the temperature of the thermostat.

2. (canceled)

3. The first device of claim 1, wherein the biometric is a heart rate of the user.

4. The first device of claim 1, wherein the biometric is determined based on data received from a second device different from the first device, the second device comprising a wearable device coupled to the user during the first time.

5. The first device of claim 1, wherein the prediction is based at least in part on a history of past biometrics of the user and associated past times at which the temperature of the thermostat was changed by the user.

6. The first device of claim 1, wherein the prediction is made using a recurrent artificial neural network tailored through machine learning of past biometrics of the user and associated past times at which the temperature of the thermostat was changed by the user.

7. The first device of claim 1, wherein the thermostat is an Internet-connected device different from the first device.

8. (canceled)

9. The first device of claim 1, wherein the instructions are executable to:
correlate the biometric to physical activity; and
make the prediction based on the biometric being correlated to physical activity.

10. The first device of claim 9, wherein the physical activity comprises cleaning.

11. (canceled)

12. The first device of claim 1, wherein changing the temperature of the thermostat commands the thermostat to one or more of: decrease operation of a heater, increase operation of an air conditioning unit.

13. A method, comprising:
presenting a graphical user interface (GUI) on a display, the GUI comprising an option at which a threshold time is settable by an end-user, the threshold time being a time prior to a predicted arrival time of the end-user at which a thermostat should change a target temperature at an arrival location in advance of the predicted arrival time;
predicting, at a first time and using a first device, that the target temperature of the thermostat should be changed in advance of a second time after the first time; and
based on the predicting and at the threshold time set via the GUI, proactively changing the temperature of the thermostat in advance of the second time.

14. The method of claim 13, comprising:
predicting, at the first time, that a user will be cooking during the second time, the predicting being based on input from a camera to identify the user as engaging in food preparation; and
predicting that the temperature of the thermostat should be changed in advance of the second time based on the predicting that the user will be cooking during the second time.

15-18. (canceled)

19. At least one computer readable storage medium (CRSM) that is not a transitory signal, the computer readable storage medium comprising instructions executable by at least one processor to:
predict, at a first time and using a first device, that a target temperature of a climate control system should be changed to a first temperature in advance of a second time that transpires after the first time;
based on the prediction, proactively change the target temperature of the climate control system to the first temperature in advance of the second time; and
while the climate control system is set to the first temperature in advance of the second time, present a first selector on a display, the first selector being selectable to change the target temperature from the first temperature to a default temperature different from the first temperature, the first selector being different from temperature up and temperature down selectors also presentable on the display.

20. (canceled)

21. The first device of claim 1, wherein the option is a first option, and wherein the settings GUI comprises a second option at which a threshold time is settable, the threshold time being a time prior to a predicted arrival time of the user at which the thermostat should begin changing temperature at an arrival location in advance of the predicted arrival time.

22. The first device of claim 1, wherein the instructions are executable to:
track the user as the user moves around a building;
responsive to the user entering a first room of the building during a first time as determined from the tracking, turn on, during the first time, a first overhead fan located in the first room; and
responsive to the user entering a second room of the building during a second time as determined from the tracking, turn on, during the second time, a second overhead fan located in the second room, the second room being different from the first room, the second time being different from the first time, the second overhead fan being different from the first overhead fan.

23. The first device of claim 1, wherein the temperature is a first temperature, and wherein the instructions are executable to:
while the thermostat is set to the first temperature in advance of the second time, present a first selector on a display of the thermostat, the first selector being selectable to change the thermostat from being set to the first temperature to being set to a default temperature different from the first temperature, the first selector being different from temperature up and temperature down selectors also presented on the display.

24. The first device of claim 23, wherein the instructions are executable to:
while the thermostat is set to the first temperature in advance of the second time, present an indication on the display of a time of day at which the thermostat will go back to being set to the default temperature.

25. The method of claim 13, wherein the option is a first option, and wherein the GUI comprises a second option different from the first option, the second option being selectable to set the first device to change target temperatures in the future based on future predictions that the thermostat should be changed.

26. The method device of claim 13, comprising:
tracking the end-user as the user moves around a building;
responsive to the end-user entering a first room of the building during a first time as determined from the tracking, turning on, during the first time, a first overhead fan located in the first room; and
responsive to the end-user entering a second room of the building during a second time as determined from the tracking, turning on, during the second time, a second overhead fan located in the second room, the second room being different from the first room, the second time being different from the first time, the second overhead fan being different from the first overhead fan.

27. The CRSM of claim 19, wherein the instructions are executable to:
while the target temperature is set to the first temperature in advance of the second time, present an indication on the display of a time of day at which the target temperature will go back to the default temperature.

28. The CRSM of claim 19, wherein the instructions are executable to:
track the user as the user moves around a building;
responsive to the user entering a first room of the building during a first time as determined from the tracking, turn on, during the first time, a first overhead fan located in the first room; and
responsive to the user entering a second room of the building during a second time as determined from the tracking, turn on, during the second time, a second overhead fan located in the second room, the second room being different from the first room, the second time being different from the first time, the second overhead fan being different from the first overhead fan.
